(19) United States
(12) Patent Application Publication
(10) Pub. No.: US 2005/0286261 A1
(43) Pub. Date: Dec. 29, 2005

(54) Laser guider for use in a machine tool

(75) Inventor: Jung-Hua Lin, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Yung Li Hsing Electric Works Co., Ltd., Taichung Hsien (TW)

(21) Appl. No.: 10/918,368

(22) Filed: Aug. 16, 2004

(30) Foreign Application Priority Data
Jun. 23, 2004 (TW) 93209881

(51) Int. Cl. F21V 7/04

(52) U.S. Cl. 362/553

(57) ABSTRACT

A laser guider includes a housing, which holds a battery power supply and defines therein a ball socket and has a coupling portion at one side for connection to a machine tool at the desired location, a laser module holder mounted in the ball socket of the housing and rotatable in X, Y and Z directions, the laser module holder having a handle extended to the outside of the housing for enabling the user to turn the laser module holder in the ball socket by hand, and a laser module mounted in the through hole of the laser module holder and electrically connected to the power supply and controllable to emit a laser beam.

### BACKGROUND OF THE INVENTION

1. Field of the Invention

The present invention relates generally to a laser guider and more particularly, to such a laser guider specifically designed for use in a machine tool.

2. Description of the Related Art

When using a machine tool to process a workpiece, for example, when using a sawing machine to cut a workpiece, a reference line may be necessary to guide the cutting operation. Normally, a laser guider is used to provide a reference line. According to conventional designs, a laser guider is not movable when installed in a machine tool. After installation of a laser guider in a machine tool, the user can only adjust the laser firing angle within a limited range in one-dimensional motion. This limitation lowers the convenience of use of the laser guider.

### SUMMARY OF THE INVENTION

The present invention has been accomplished under the circumstances in view. It is the main object of the present invention to provide a laser guider, which is detachably connectable to a machine tool and can conveniently adjusted to change the laser pointing angle in X, Y and Z directions.

To achieve this object of the present invention, the laser guider comprises a housing, the housing comprising a ball socket formed in one end thereof in communication with the atmosphere, a power supply installed in an opposite end thereof, and a coupling portion formed in one lateral side thereof for connection to a machine tool; a laser module holder mounted in the ball socket of the housing and rotatable in X, Y and Z directions, the laser module holder having a through hole and a handle extended from the periphery thereof to the outside of the housing for turning the laser module holder in the ball socket by hand; and a laser module mounted in the through hole of the laser module holder and electrically connected to the power supply and controllable to emit a laser beam.

### BRIEF DESCRIPTION OF THE DRAWINGS

FIG. 1 is an elevational view of a laser guider according to the present invention.

FIG. 2 is an exploded view of the laser guider according to the present invention.

FIG. 3 is an end view of the laser guider according to the present invention.

FIG. 4 is a sectional view of the laser guider according to the present invention.

FIG. 5 is a schematic drawing showing an installation example of the present invention.

FIG. 6 corresponds to FIG. 5, showing another adjustment example of the laser guider.

FIG. 7 is a schematic drawing showing another installation example of the present invention.

FIG. 8 is a schematic drawing showing another installation example of the present invention.

### DETAILED DESCRIPTION OF THE INVENTION

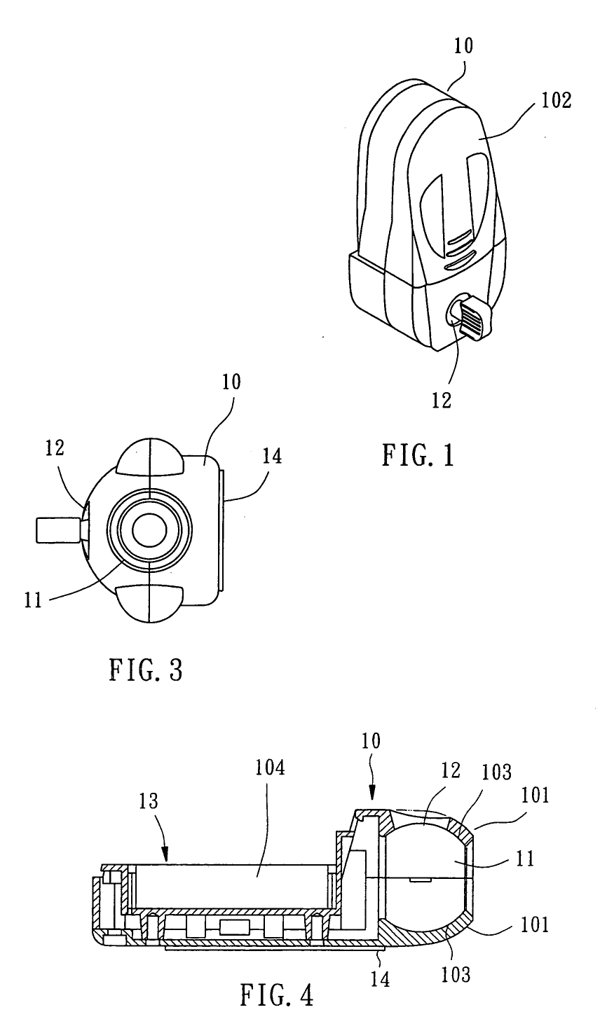

Referring to FIGS. 1˜4, a laser guider in accordance with the present invention is shown comprised of a housing 10, a laser module holder 20, and a laser module 30.

The housing 10 comprises a ball socket 11 formed in one end (front end) in communication with the outside, a through hole 12 extended from the ball socket 11 to one lateral side, a power supply 13 installed in the other end (rear end), and a coupling portion 14 formed in the other lateral side. By means of the coupling portion 14, the housing 10 is connectable to a machine tool. According to this embodiment, the housing 10 is formed of two shells 101 and a cap 102. Each of the two shells 101 has a semispherical recess 103. When the two shells 101 are fastened together, the two semispherical recesses 103 of the shells 101 form the aforesaid ball socket 11. One of the shells 10 has a receiving hole 104 for accommodating the power supply 13. According to this embodiment, the power supply 13 is formed of a set of battery cells. The cap 102 is adapted to close the receiving hole 104, holding the power supply 13 in the receiving hole 104. The aforesaid coupling portion 14 can be made having an outer thread (or inner thread) for threading into an inner thread (or onto an outer thread) at the machine tool. Alternatively, the coupling portion 14 can be provided with a magnet for fastening to the machine tool by means of magnetic attraction.

The laser module holder 20 is a spherical member rotatably mounted in the ball socket 11 of the housing 10, having a through hole 21 and a coupling portion 22. After installation of the laser module holder 20 in the ball socket 11, a handle 23 is inserted through the through hole 12 and fastened to the coupling portion 22. Through the handle 23, the user can rotate the laser module holder 20 in the ball socket 11 in X, Y and Z directions.

The laser module 30 is mounted in the through hole 21 of the laser module holder 20 and electrically connected to the power supply 13, and controllable to emit a laser beam.

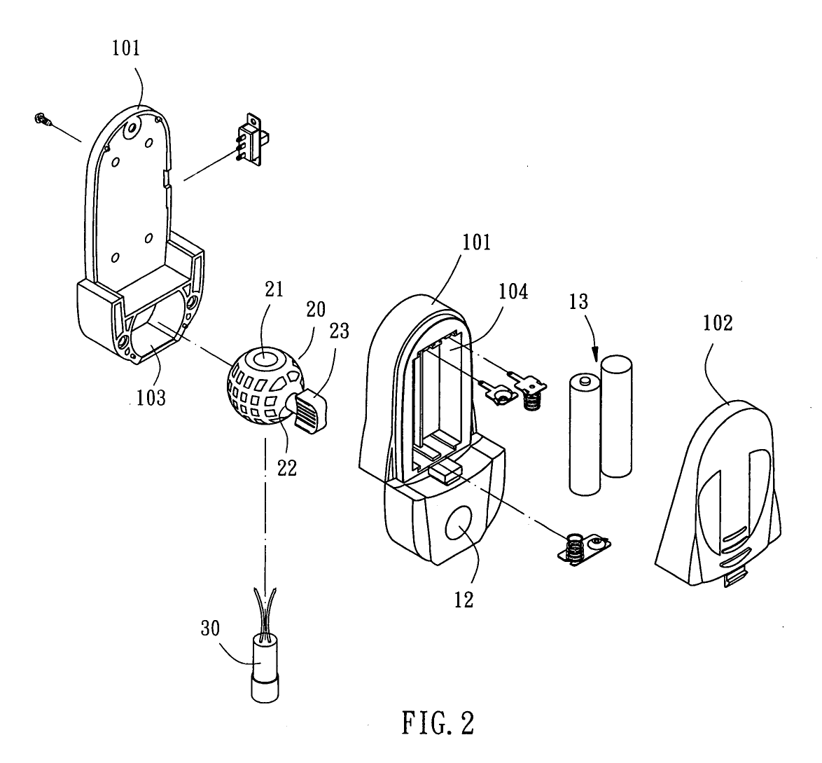

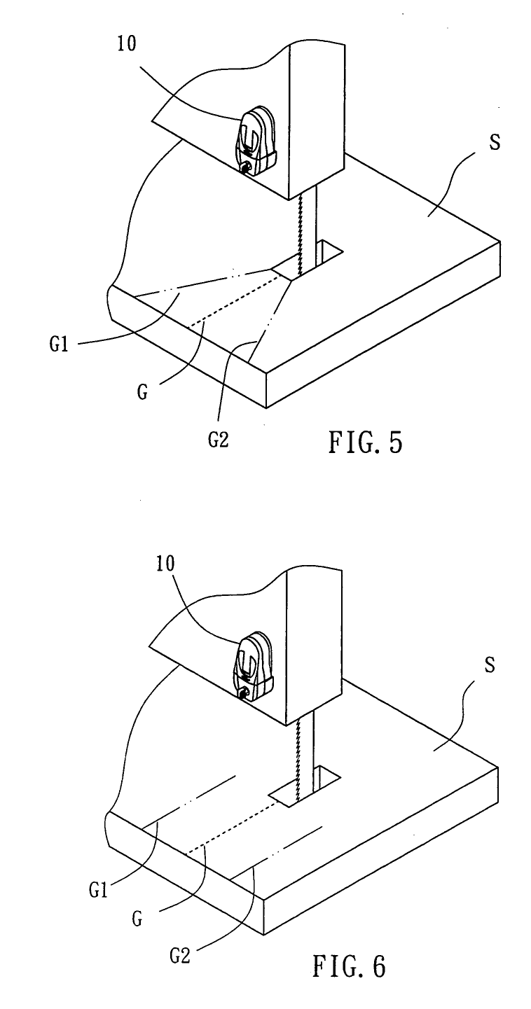

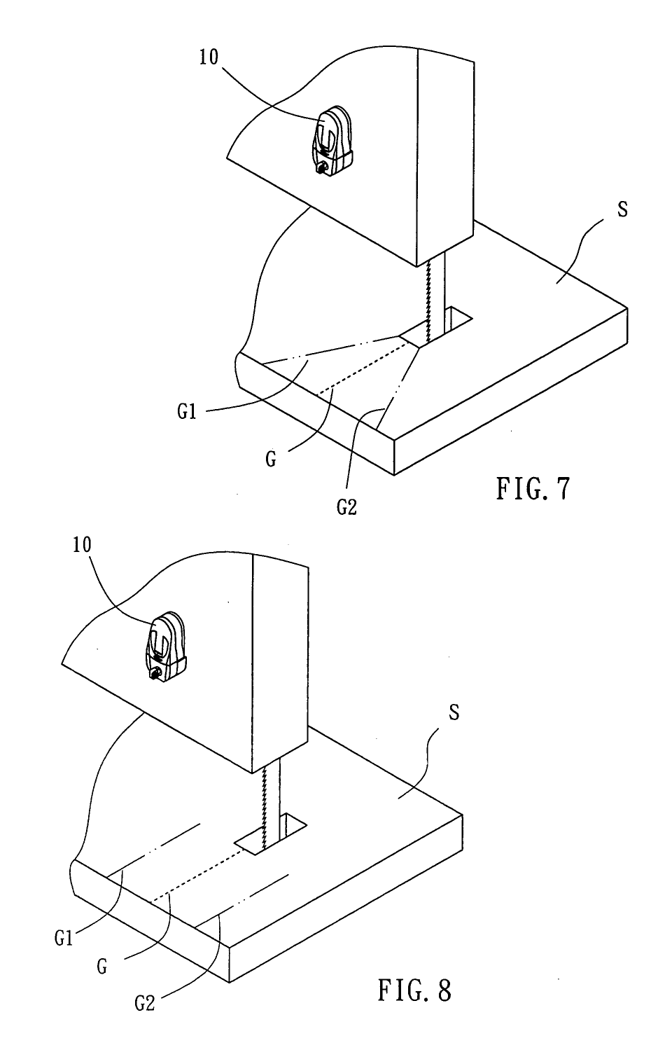

Referring to FIGS. 5˜8 and FIGS. 1 and 2 again, when in use, the laser guider can be installed in the machine tool at any location near the worktable. FIGS. 5 and 6 show an installation example of the present invention. According to this installation example, the laser guider is installed in a sawing machine right above the saw table S, and controlled to emit a laser beam onto the saw table S, forming a guideline G. The user can move the handle 23 to bias the angle of the guideline toward the left or right side as indicated by G1 or G2 in FIG. 5. The user can also operate the handle 23 to turn the laser module holder 20 and to further shift the guideline to the left side or right side as shown in FIG. 6. FIGS. 7 and 8 show another installation example of the present invention. According to this installation example, the laser guider is installed in a sawing machine not just right above the saw table S but at a distance away from the cutting position (saw blade).

Although a particular embodiment of the invention has been described in detail for purposes of illustration, various modifications and enhancements may be made without departing from the spirit and scope of the invention. Accordingly, the invention is not to be limited except as by the appended claims.

1. A laser guider comprising:
a housing, said housing comprising a ball socket formed in one end thereof in communication with the atmosphere, a power supply installed in an opposite end thereof, and a coupling portion formed in one lateral side thereof for connection to a machine tool;
a laser module holder mounted in said ball socket of said housing and rotatable in X, Y and Z directions, said laser module holder having a through hole and a handle extended from the periphery thereof to the outside of said housing for enabling the user to turn said laser module holder in said ball socket by hand; and
a laser module mounted in the through hole of said laser module holder and electrically connected to said power supply and controllable to emit a laser beam.

2. The laser guider as claimed in claim 1, wherein said housing comprises a through hole extended from said ball socket to the outside for the passing of said handle of said laser module holder.

3. The laser guider as claimed in claim 1, wherein said housing is comprised of two shells, said shells each having semispherical recess, the semispherical recesses of said shells being matched to form said ball socket.

4. The laser guider as claimed in claim 3, wherein one of said shells has a receiving hole for accommodating said power supply.

5. The laser guider as claimed in claim 4, wherein said housing further comprises a cap adapted to close said receiving hole.

6. The laser guider as claimed in claim 1, wherein the coupling portion of said housing is provided with a magnet for connection to a machine tool by magnetic attraction.
